(19) United States
(12) Patent Application Publication
(10) Pub. No.: US 2025/0172656 A1
(43) Pub. Date: May 29, 2025

(54) PHASED ARRAY AUTOMOTIVE RADAR

(71) Applicant: MaxLinear, Inc., Carlsbad, CA (US)

(72) Inventor: Curtis Ling, Carlsbad, CA (US)

(73) Assignee: MaxLinear, Inc., Carlsbad, CA (US)

(21) Appl. No.: 19/030,972

(22) Filed: Jan. 17, 2025

Related U.S. Application Data
(63) Continuation of application No. 18/172,282, filed on Feb. 21, 2023, now Pat. No. 12,235,381.
Application No. 18/172,282 is a continuation of application No. 16/372,600, filed on Apr. 2, 2019, now Pat. No. 11,585,890.
(60) Provisional application No. 62/651,357, filed on Apr. 2, 2018.

(51) Int. Cl. G01S 7/03; G01S 13/931

(52) U.S. Cl. CPC G01S 7/032; G01S 13/931

(57) ABSTRACT

A system comprises a first phased array radar assembly configured to be attached to a vehicle. The first phased array radar assembly includes a first plurality of antennas arranged in an array and attached to a circuit board. The system also includes one or more circuits attached to the circuit board. Each of the one or more circuits includes transmitter circuitry communicatively coupled to a subset of the first plurality of antennas and receiver circuitry communicatively coupled to the subset of the first plurality of antennas.

### PRIORITY CLAIM

This application is a continuation of U.S. patent application Ser. No. 18/172,282 titled “Phased Array Automotive Radar” filed on Feb. 21, 2023, which is a continuation of U.S. patent application Ser. No. 16/372,600 titled “Phased Array Automotive Radar” filed on Apr. 2, 2019, which claims priority to U.S. Provisional Patent Application No. 62/651,357 titled “Phased Array Automotive Radar” filed on Apr. 2, 2018, each of which are hereby incorporated by reference in their entireties.

### BACKGROUND

Limitations and disadvantages of conventional radar systems and methods will become apparent to one of skill in the art, through comparison of such approaches with some aspects of the present method and system set forth in the remainder of this disclosure with reference to the drawings.

### BRIEF SUMMARY

Methods and systems are provided for phased array automotive radar, substantially as illustrated by and/or described in connection with at least one of the figures, as set forth more completely in the claims.

### BRIEF DESCRIPTION OF THE DRAWINGS

FIGS. 1A-1C show an example phased array system in accordance with an example implementation of this disclosure.

FIGS. 2A and 2B show an architecture of a phased array transceiver system in accordance with an example implementation of this disclosure.

FIG. 2C shows an example implementation of a transceiver system on chip (SoC) suitable for use in a phased array radar system in accordance with an example implementation of this disclosure.

FIG. 3 shows an example antenna pattern of phased array radar system in accordance with an example implementation of this disclosure.

FIG. 4A shows an example phased array radar system integrated into an automobile in accordance with an example implementation of this disclosure.

FIG. 4B shows an automobile comprising a plurality of phased array radar systems in accordance with an example implementation of this disclosure.

FIG. 4C shows example operation of a phased array radar system.

### DETAILED DESCRIPTION

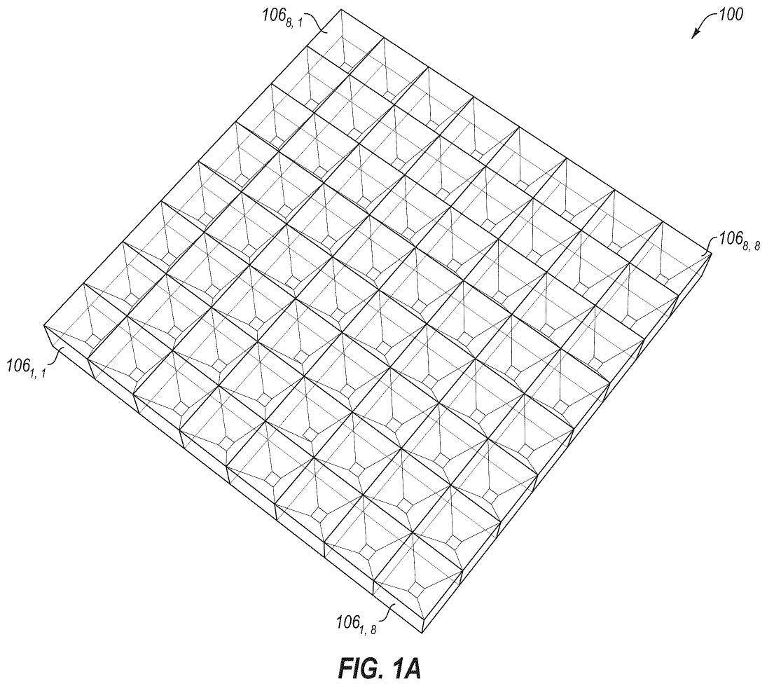

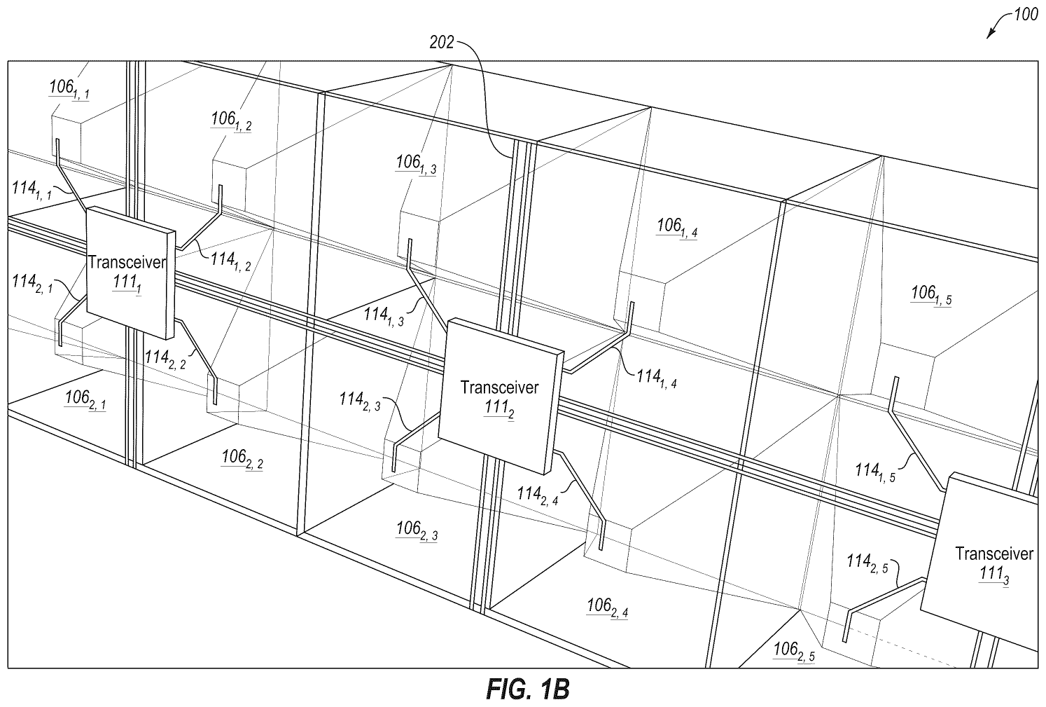

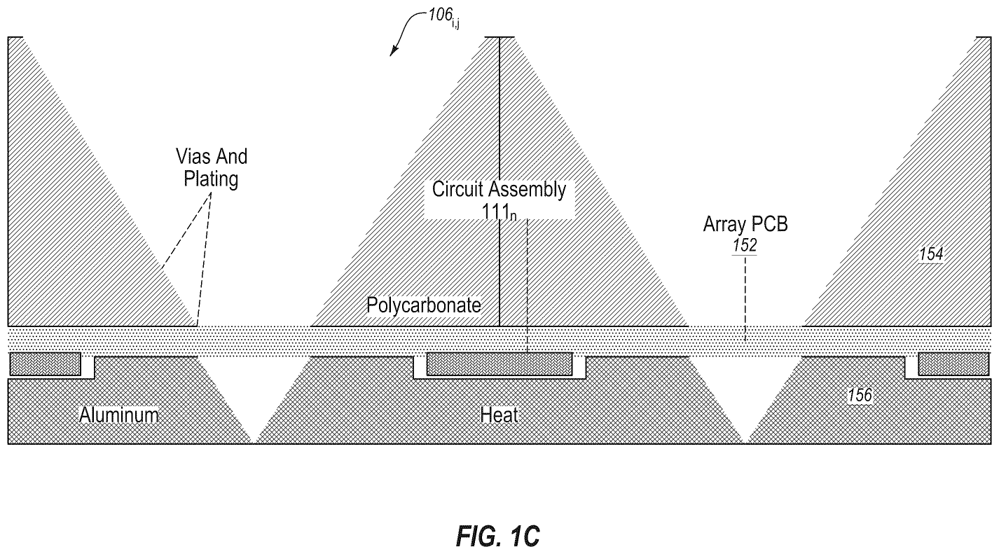

FIG. 1A-1C illustrate an example phased array system 100. FIG. 1A shows a front view and FIG. 1B shows a rear view.

The phased array system 100 comprises a plurality of antenna element elements arranged in a 2-dimensional array. Each antenna element is called out as 106_{i,j}, where i is an integer corresponding to the antenna element's row index in the array (0<=i<=I) and j is an integer corresponding to the antenna element's column index in the array (0<=j<=J). In the example shown there are 8 antenna elements in each row and 8 antenna elements in each column, (i.e., I=8 and J=8), but in practice any number of antenna elements may be used. The transmission and reception of signals by the system 100 may take advantage of beamforming and may be particularly configured for addressing possible issues (interference, etc.) and/or to provide added features, as described below.

The example phased array system 100 of FIGS. 1A-1C comprises an array of N antenna element elements 106 (e.g., N=64 elements, in 8×8 arrangement, as shown in the non-limiting example implementation illustrated in FIG. 1A), and one or more circuits assemblies 111 for handling and/or supporting transmission and reception of signals via the array of antenna element elements 106. The circuit assemblies 111 are operable to perform various signal processing related functions, as well as (optionally) other functions (e.g., control, storage, etc.) in support of the transmission and reception of signals via the antenna elements 106. In the example implementation shown, the system 100 comprises N (an integer) circuit assemblies 111ₙ (1<=n<=N), each of which is operable to transmit and/or receive via a respective M (an integer) of the antenna elements 106 (N=16 and M=4 in the example shown).

As shown in the example implementation of FIG. 1C, antenna elements 106, of which two elements are shown in the cross-section slice depicted in FIG. 1C, the antenna elements 106 may be formed using carved horn structure 154, which may comprise polycarbonate (or other suitable material) substrate with conductive plating (e.g., aluminum) covering the surfaces forming the horn-shaped antenna elements. The antenna elements 106 may be mounted to a rigid base structure 156 (e.g., made of aluminum). In between the base structure 156 and the horn structure 154 may be one or more printed circuit board (PCB) 152 that provides RF traces interconnecting the circuit assemblies 111 and the antenna elements 106.

Phased array systems, such as the phased array system 100, offer various advantages and/or improvements over conventional antenna systems, such as dish-based designs. In this regard, because of their light weight, small form factor, and use of beam steering (e.g., beamforming), phased array systems are preferable over traditional dish-based designs. The elimination of dish and related components (e.g., the frequency duplexer, large power amplifier (“PA”), etc.) allows for installation at a wider range of sites, with lower cost of installation and operation (e.g., automatic alignment). Accordingly, phased array systems may be installed in a more flexible manner compared to dish-based designs, allowing installation options not possible or practical with traditional designs—e.g., mounting to sides of buildings, etc.

Phased array systems may have lower costs (e.g., fewer, smaller, and less expensive circuits, etc.). Also, the use of software-defined multiband array operation adds more flexibility. For example, the elimination of certain components (e.g., duplexers) allows the array-based systems to operate across a wide frequency range. Greater link reach may be achieved for the same dish size (due to, e.g., greater transmitter power, interference suppression, etc.). Operations may be improved (e.g., lower operating expenditures, greater frequency reuse, lower weight, etc.). Further, phased array systems may have superior thermal dissipation characteristics. In addition, the same core technology may be used for different interfaces and/or frequencies bands, allowing for common software and hardware development.

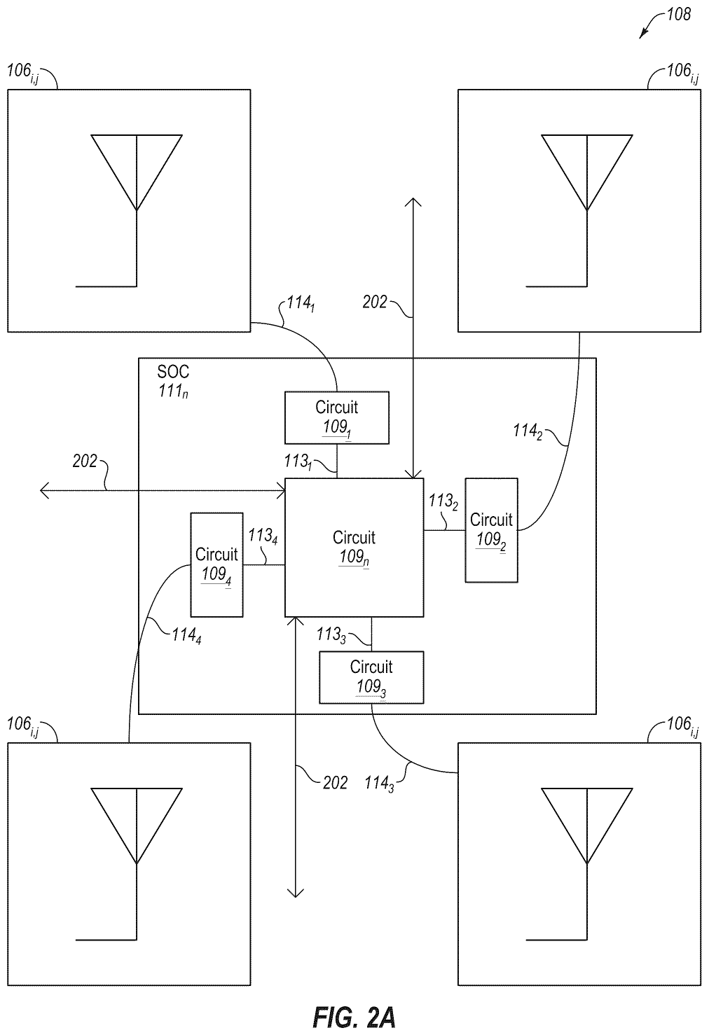

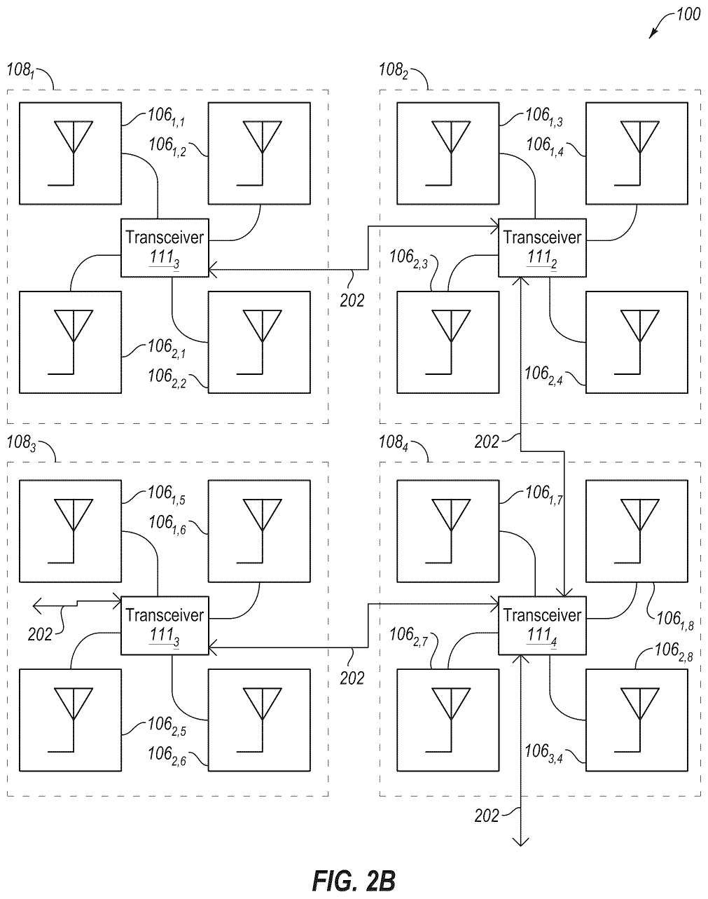

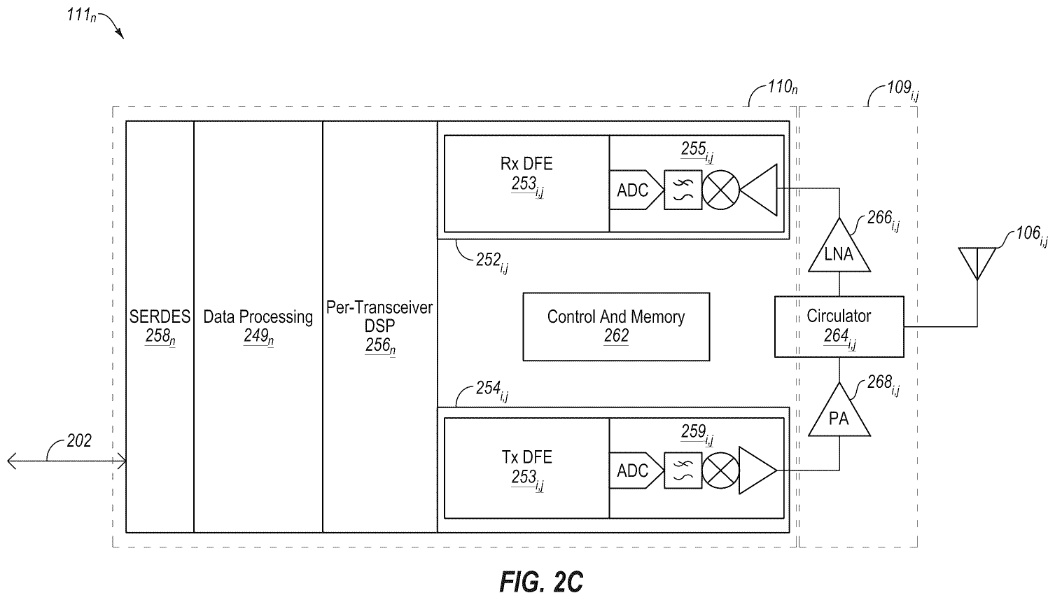

FIGS. 2A and 2B show an example architecture of a phased array transceiver system. In the example implementation of FIGS. 2A and 2B, each circuit assembly 111ₙ comprises a highly-integrated transceiver system on chip (SoC) 110ₙ and a plurality of off-chip circuits 109ₘ, each of the circuits 109ₘ being associated with a respective one of the M antenna elements 106 via which the SoC 110ₙ transmits and/or receives. An example implementation of the SoC 110ₙ is described below with reference to FIG. 2C. An example implementation of the circuits 109 is described below with reference to FIG. 2C. The N SoCs 110₁-110_{N} are interconnected via interconnect 202, which may, for example, comprise a high-speed serial bus via which the SoCs 110₁-110_{N} can exchange data and control signaling.

In an example implementation, each circuit 111 is operable to: (1) transmit, in one or more desired directions using beamforming, millimeter wave signals (e.g., in the 76 to 81 GHz band) via its antenna elements 106; (2) receive reflections of the transmitted signal, from one or more desired directions using beamforming; and (3) process the received reflections to generate a representation of the “scene” on which the signals are incident. For example, the scene representation may be a voxel grid, with each voxel corresponding to a particular location in 4-Dimensional space (e.g., its GPS coordinates and time at which the coordinates were measured). Also, each voxel may have additional information associated with it such as, for example, a strength of the reflection, a spectrum of the reflection, a velocity of an object (e.g., car, pedestrian, etc.) located at the voxel, and/or a material composition (e.g., a quantification of how hard or soft) of an object located at the voxel.

Shown in FIG. 2C are details of an example implementation of the SoC 110ₙ and a circuit 109_{i,j}. In an example implementation, the SoC 110ₙ is a CMOS device and the LNA 266_{i,j} and PA 268_{i,j} are PHEMT devices. In other example implementations, one or more components of the circuits 109_{i,j} may be integrated on the CMOS chip 110ₙ.

The example SoC 110ₙ comprises serialization and deserialization (SERDES) circuitry 258, per-transceiver digital signal processing (DSP) circuitry 256, one or more receive front-end circuits 252_{i,j}, one or more transmit front-end circuits 254_{i,j}, and a portion of one or more (four, in an example implementation) circulator 264_{i,j}. Although only one receive front-end circuit 252_{i,j} and one transmit front-end circuit 254_{i,j} are shown for simplicity of illustration, the SoC 110ₙ may comprise any number of instances of these circuits. In the example implementations of FIGS. 1A, 1B, 2A, and 2B, for example, the SoC 110ₙ may comprise four instances of receive front-end circuit 252_{i,j}—one for each of the four antenna elements 106_{i,j} via which the SoC 110ₙ receives, and four instances of transmit front-end circuit 254_{i,j}—one for each of the four antenna elements 106_{i,j} via which the SoC 110ₙ transmits.

The example circuit 109_{i,j} comprises a low-noise amplifier 266_{i,j}, a power amplifier 268_{i,j}, and a portion of the circulator 264_{i,j}. Although only one circuit 109_{i,j} is shown for simplicity of illustration, the circuit assembly 111ₙ may comprise any number of instances of this circuits. In the example implementations of FIGS. 1A, 1B, 2A, and 2B, for example, the circuit assembly 111ₙ may comprise four instances—one for each antenna 106_{i,j} via which the SoC 110ₙ transmits and/or receives.

Each of the receive front-end circuits 252_{i,j} comprises an analog front-end circuitry (AFE) 255_{i,j} and a digital front-end circuit (DFE) 253_{i,j} operable to process a millimeter wave signal (e.g., in the band from 76 to 81 GHz) from antenna elements 106_{i,j}.

The processing by AFE 255_{i,j} may comprise, for example, low noise amplification, down-conversion, filtering, and analog-to-digital conversion by the AFE 255_{i,j} so as to output a intermediate frequency or digital baseband signal to the DFE 253_{i,j}. For example, each Rx AFE 255_{i,j} may downconvert a received 76 to 77 GHz band to a 1-GHz-wide baseband signal which the corresponding ADC 254 may then digitize to generate a 1-GHz-wide digital signal. As another example, each Rx AFE 255_{i,j} may downconvert a received 76 to 81 GHz band to a 5 GHz wide baseband signal which the corresponding ADC 254 may then digitize to generate a 5-GHz-wide digital signal.

The processing by DFE 253_{i,j}, may comprise, for example, channel estimation and equalization.

For received signals, the DSP circuit 256ₙ is operable to process the digitized signals from the plurality of DFEs 253_{i,j} to recover information conveyed by the received signals. Such information may be conveyed by characteristics (e.g., latency, Doppler shift, signal strength, etc.) of the received signals, as is the case in a conventional radar system, and/or may be data that was modulated onto the received signals. In an example implementation in which the millimeter wave signals are modulated by a data signal, the processing performed by the digital signal processing circuit 256ₙ may include demodulation. For example, the millimeter wave signals transmitted by circuit assembly 111 may comprise OFDM frames and each digital signal processing circuit 256ₙ may be operable to demodulate the received signals using a discrete Fourier transform. The digital signal processing circuit 256ₙ may then be operable to demap the modulated signal according to one or more symbol constellations, deinterleave the demapped bits, and decode the demapped bits. The recovered bits may then be provided to the control and memory subsystem 262 and/or to SERDES 258_{i,j} for output onto the bus 212.

Received signal processing by DSP 256ₙ may comprise, for example, applying a determined phase shift to the signals received from each DFE 253_{i,j} and then combining the signals so as to achieve the desired beamforming. The beamforming may comprise time-domain beamforming in which one or more sets of phase and amplitude coefficients is applied to each of the signals 255 in the time domain. Alternatively, or additionally, the beamforming may comprise frequency-domain beamforming in which the signals 255 are first transformed to the frequency domain (e.g., via a DFT) and then each subband (e.g., each OFDM bin or group of OFDM bins) is processed using a corresponding one or more beamforming matrices determined for that subband. In this manner, different subbands may be communicated on beams pointed in different directions.

Received signal processing performed by the digital signal processing circuit 256ₙ may comprise spectral analysis of the received signals. The spectral analysis may comprise, for example, mixing received signals with one or more reference signals to generate a difference signal. The spectral analysis may comprise, for example, performing a discrete Fourier transform on received signals. The spectral analysis may be used to, for example, determine Doppler shift of received signals and/or to generate spectral signatures of detected objects in the scene (i.e., objects off of which the received signals reflected).

Received signal processing performed by the digital signal processing circuit 256 may comprise separating different signals (e.g., originating from different ones of the transceivers 111₁-111_{N}). The may comprise, for example, correlating the received signals with different orthogonal codes and/or pseudorandom sequences used by different ones of the transceivers 111₁-111_{N}. Alternatively, or additionally, separating different transmitted signals (e.g., to determine which transceiver 111ₙ sent which signal) may comprise directly recovering a respective identifier (e.g., a unique identifier such as a MAC address or similar) modulated onto each of the millimeter wave signals. The ability to distinguish which, if any, energy arrived from each transceiver 111₁-111_{N} may be useful for performing radar, positioning, and communication functions. For the radar and positioning functions, for example, the identification of which of transceivers 111₁-111_{N} sent any particular received signal may be used for determining the position and angle from which the signal was transmitted (since the different transceivers 111₁-111₈ are at different positions in the array 100), which may be used for determining precise distance to, and location of, objects in the scene. For the communication function, for example, the identification of which of transceivers 111₁-111_{N} sent any particular received signal may be used in a manner similar to a “from” address in many networking protocols.

The data processing circuitry 249ₙ is operable to process data output by the digital signal processing circuitry 256ₙ. Such processing may comprise, for example, implementing algorithms to generate a representation of the scene detected using the radar function. Based on the angle, strength, timing, spectral content, and/or other characteristics of the received signals, the data processing circuitry 249, may generate a 2D pixel grid or 3D voxel grid. In an example implementation, each pixel or voxel may indicate an absolute position to which it corresponds, the strength of returns, if any, received from that location, spectral content of returns, if any, received from that location, time(s) at which returns were received from that location, and/or at which the pixel or voxel data was updated.

The data processing circuitry 249ₙ may also be operable to process data received from the data bus 202. For example, positioning information may be received via the bus 202 (e.g., GPS coordinates from a GPS receiver) and combined with data recovered from the digital processing circuitry 249ₙ for performing a positioning function.

The processing performed by data processing circuitry 249ₙ of data output by digital signal processing circuitry 256 may comprise, for example, preparing data for output onto the data bus 202. For example, a scene representation generated from the output of the digital signal processing circuity 256 may be transmitted onto the data bus 202.

Each of the Tx AFEs 259_{i,j} is operable to receive a digital baseband signal from Tx DFE 257_{i,j}, convert the signal to analog, upconvert the signal to a millimeter wave (e.g., a 1 GHz to 5 GHz wide signal in the band from 76 to 81 GHz), and amplify the millimeter wave signal for output to antenna element 106_{i,j}.

For transmit, the digital signal processing circuitry 256ₙ is operable to process one or more data streams from data processing circuitry 249ₙ to generate a plurality (four in the example shown) of digital baseband signals. Transmit processing performed by digital signal processing circuitry 256ₙ may comprise, for example, encoding, interleaving, bit-to-symbol mapping, frequency mapping (mapping of symbols to subbands), modulation (e.g., using discrete Fourier transform and/or inverse discrete Fourier transform) beamforming, and/or the like.

The transmit processing performed by the digital signal processing circuit 256ₙ may comprise generating modulated signals to be modulated onto one or more carriers. For example, the digital signal processing circuit 256ₙ may output an OFDM signal.

The transmit processing performed by the digital signal processing circuit 256ₙ may comprise beamforming. The beamforming may comprise time-domain beamforming and/or frequency-domain beamforming.

Transmit operations performed by the data processing circuit 249ₙ may comprise generating one or more data signals for modulation onto the millimeter wave signals transmitted by the transceiver 111ₙ. The datastreams may, for example, be read from memory of the transceiver 111ₙ (e.g., an identifier of the module 111ₙ) and/or generated algorithmically (e.g., timestamps generated based on a clock of the control portion of subsystem 262). Additionally, or alternatively, the data may be received from bus 202 via bus controller 258ₙ. The data processing circuit 249ₙ may packetize and/or otherwise format the data.

The bus controller circuitry 258ₙ is operable to relay data between the data bus 202 and the circuitry of the SoC 110ₙ. The bus 202 may, for example, be a high speed serial bus in which case the bus controller circuitry 258ₙ is operable to perform serialization and deserialization for communicating over the bus 202.

The control portion of subsystem 262 is operable to manage operations of the SoC 110ₙ (e.g., implement a state machine and/or other control logic that controls the configuration of the other components of the receive transceiver 111ₙ). The control portion of subsystem 262 may, for example, configure beamforming matrices used by the digital signal processing circuitry 256ₙ. For example, the control portion of subsystem 262 may determine that particular directions are of interest at a given time and may configure the beamforming to point beams in those particular directions. Particular directions may be of interest because, for example, it is desired to determine more information about objects located in that direction and/or to listen for communications that are expected to come from that direction. Directions of interest may be determined based on, for example, data received via the data bus 202, data carried in previously received millimeter wave signals, and/or scene representations generated from previously received signal reflections.

The memory portion of subsystem 262 is operable to store relatively large amounts (e.g., hundreds of megabits) of information of a variety of forms. For example, beamforming matrices, an identifier of the transceiver 111ₙ, scrambling codes, and messages received from and/or to be communicated to (via data bus 202 and/or via millimeter wave signals) other transceivers 111ₙ are just some examples of the information which may be stored in the memory and readily accessible to the transceiver 111ₙ.

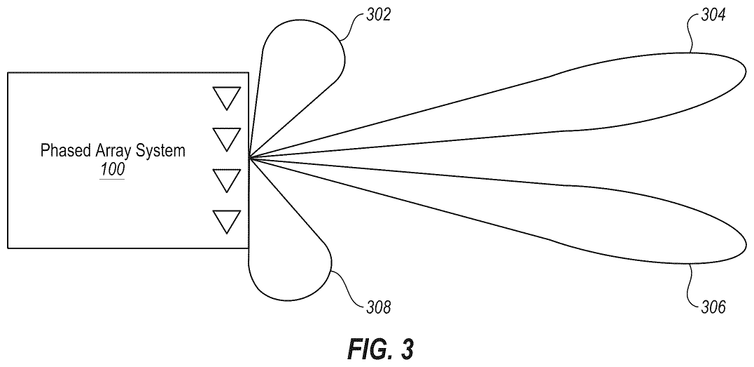

FIG. 3 shows an example antenna pattern of phased array radar system. In the example shown, for desired lobes—302, 304, 306, and 308 are formed. For example, lobes 302 and 308 may be used for identifying objects that are relatively close and off to the side of the phased array system 100, and the lobes 304 and 306 may be used for looking further in the distance (e.g., in the direction of travel of automobile to which the phased array is mounted). As another example, the lobes 302 and 308 may receive returns from the nearby road surface and the Doppler of such returns may be used for calculating the speed of the phased array (i.e., of the automobile to which it is mounted). As another example, lobes 302 and 308 may be used for directly communicating with another phased array system 100 off to the side of the depicted phased array system 100 (e.g., where multiple phased arrays system 100 are mounted to a single vehicle), and lobes 304 and 306 may be used for communicating with other transceivers by bouncing the signals off of objects in the scene.

Although four beams/lobes are shown for illustration, the phased array radar system is not limited to any particular number of beams/lobes. There may be different numbers of beams at different times based on, for example, the number of objects and/or angles of objects it is determined necessary or desirable to identify or track at any given time. There may be different numbers of beams at different times based on, for example, number and/or location of other transceivers with which it is necessary or desirable to communicate at any given time. Similarly, the directions of the beams may vary over time. For example, the directionality of any one or more of the beams 302, 304, 306, and 308 may change periodically, based on what is detected in the scene, based on desired communication to be sent or received, and/or the like.

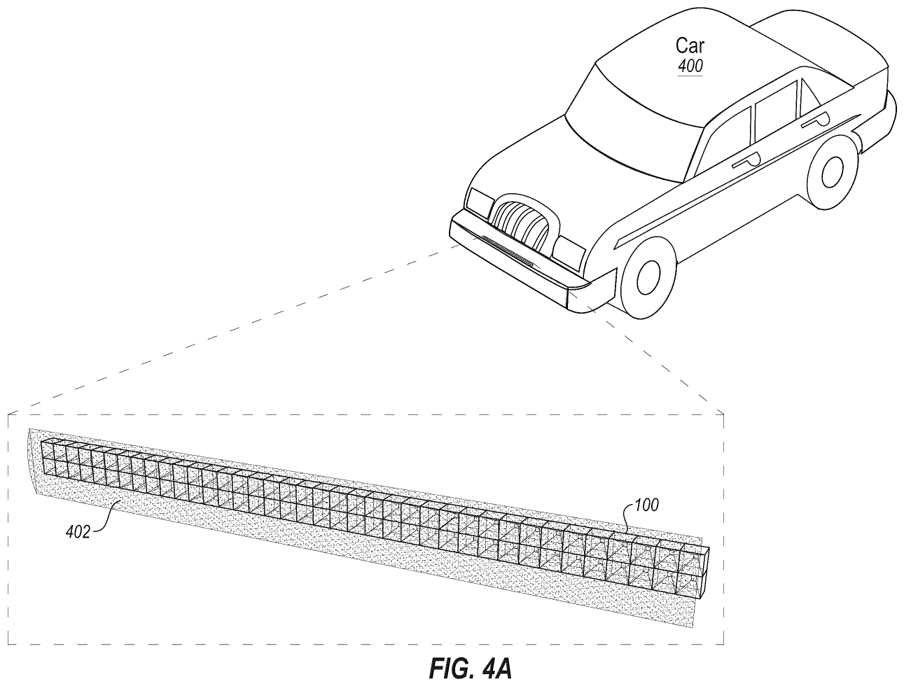

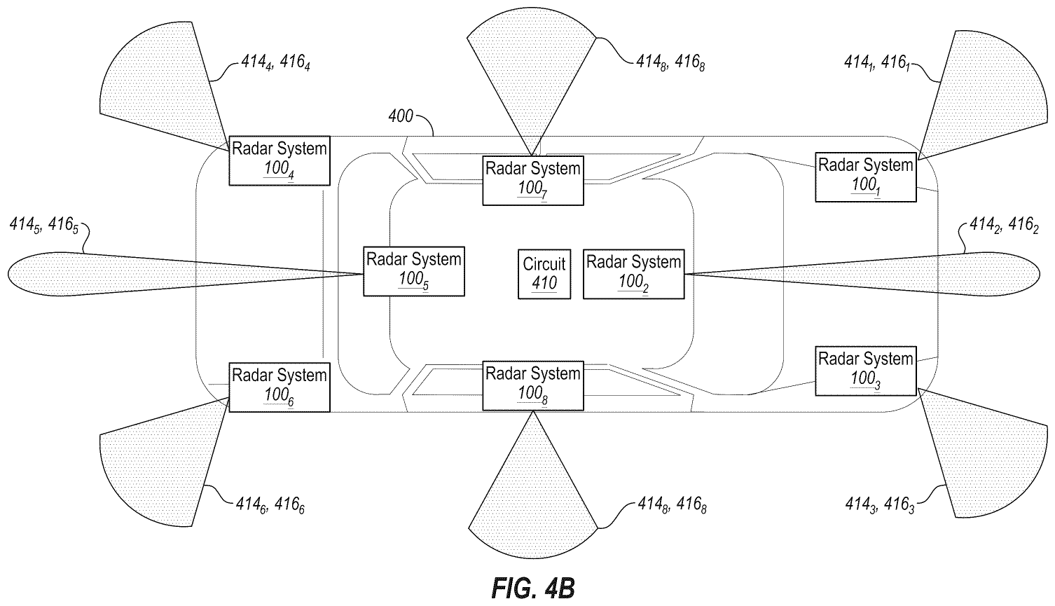

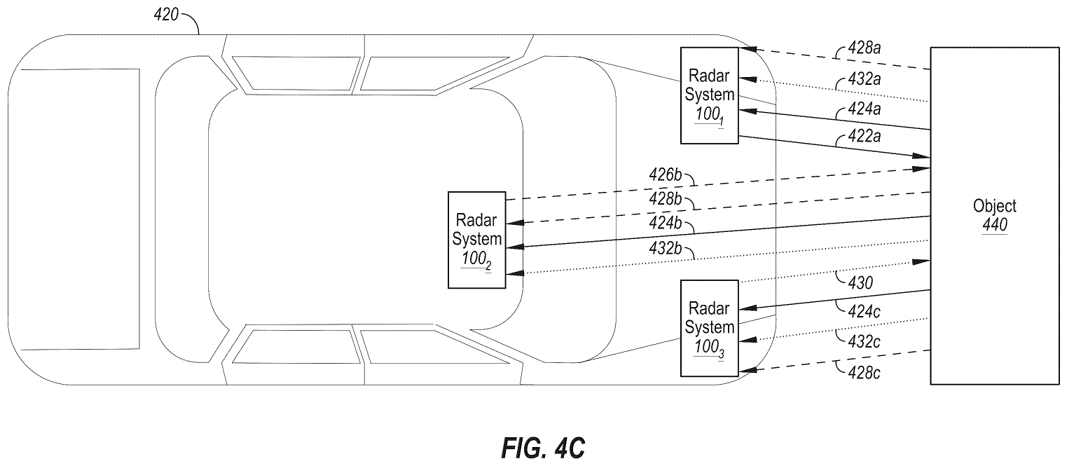

FIG. 4A shows an example phased array radar system integrated into an automobile. A 2×64 element antenna array is placed in/behind the bumper of the automobile 400. In the example implementation the array comprises a lens 402 that further controls the directionality of the antenna.

FIG. 4B shows an automobile 400 comprising a plurality of phased array radar systems 100 (labeled with subscripts ‘1’ through ‘8’). Although the example automobile 400 comprises eight phased array radar systems 100 for illustration, any number may be present. Each phased array radar system 100 has a corresponding receive antenna pattern 414 and transmit antenna pattern 416 (for clarity of illustration, the transmit and receive patterns are shown as the same, but they need not be). Each phased array radar system 100 may perform: (1) a radar function, (2) a positioning function, and (3) a communication function.

The radar function comprises transmitting millimeter wave signals and processing the reflections/returns of such signals to detect the presence of, identity of, direction of, distance to, and/or speed of objects in the environment surrounding the automobile 400 (the “scene”).

The positioning function comprises use of the same millimeter wave signals used for the radar function to improve upon coarse position determined through other mechanisms such as GPS.

The communication function comprises communicating data among the phased array radar systems 100 using the same millimeter wave signals as are used for the radar function. Such data may include, for example, pixel or voxel data (and time and position metadata) generated using the radar and positioning functions.

Through a combination of the radar function, the positioning function, and the communication function, the phased array radar systems 100 are operable to generate a scene representation (e.g., 2D pixel grid or 3D voxel grid) where the absolute time of capture of the scene representation and the absolute position of the pixels (2D) or voxels (3D) in the scene representation are known.

The circuitry 410 represents other circuitry of the automobile 400 such as one or more transceivers (e.g., cellular, Wi-Fi, Bluetooth, GPS, etc.), instrumentation (e.g., entertainment system, driver indicators/gauges, driver controls), sensors for safety systems, etc. The circuitry 410 may be communicatively coupled to the phased array radar systems 100 via a CANbus, for example. The circuitry 410 may be operable to process data from the phased array systems 100₁-100₈ and take action (e.g., trigger driver alerts, transmit messages via one or more of its transceivers, trigger braking or other safety systems, etc.) in response to such data. The circuitry 410 may also generate data which it may pass to the phased array systems 100₁-100₈ for communication to a remote phased array radar system 100 (e.g., that is mounted to another automobile and/or to infrastructure such the road, sign post, stop-light, etc.) In an example implementation, the circuitry 410 may comprise a cell phone that connects to an electronics system of the automobile 400 via USB, Bluetooth, Wi-Fi, or any other suitable interface and then the electronics system 410 of the automobile 400 leverages the cellular transceiver of the circuitry 410 for connecting to a cellular network.

FIG. 4C shows example operation of a phased array radar system. The radar system 100₁ transmits millimeter wave signal 422 which reflects off of object 440 (e.g., the car in front of the automobile 400) and is then received as signal 424ₐ by radar system 100₁, signal 424_{b} by radar system 100₂, and signal 424_{c} by radar system 100₃. The radar system 100₂ transmits millimeter wave signal 426 which reflects off of object 440 and is then received as signal 428ₐ by radar system 100₁, as signal 428_{b} by transceiver 100₂, and as signal 428_{c} by radar system 100₃. The radar system 1003 transmits signal 430 which reflects off of object 440 and is then received as signal 432ₐ by radar system 100₁, as signal 432_{b} by radar system 100₂, and as signal 432_{c} by radar system 1003.

As discussed above, each of the radar systems 100₁, 100₂, and 100₃ may be operable to separate its respective received signals. That is, radar system 100₁ can distinguish between energy of signal 424ₐ, energy of signal 428ₐ, and energy of signal 432ₐ. Similar can be said for each of radar systems 100₂ and 100₃. This separation may be possible because, for example, the signals 422, 426, and 430 are frequency division multiplexed, time division multiplexed, spatially multiplexed, and/or code division multiplexed. Coordination for carrying out such multiplexing may be achieved as a result of, for example: factory settings of the three radar systems 100₁, 100₂, and 100₃; passing control/coordination information among the radar systems 100₁, 100₂, and 100₃ via the data bus 202; passing control/coordination information among the radar systems 100₁, 100₂, and 100₃ via the millimeter wave signals 422, 426, 430, and/or the like.

While the present disclosure specifically addresses aspects of the invention in connection with an automobile, the disclosure contemplates that aspects of the invention may be used in connection with any type of vehicle or mobile machinery.

In accordance with an example implementation of this disclosure, a system comprises a first phased array radar assembly (e.g., 100₁) configured to be attached to an automobile. The first phased array radar assembly comprises a first plurality of antennas (e.g., 106_{1,1} to 106_{2,8}) arranged in an array and attached to a circuit board (e.g., 152). The system also comprises one or more circuits (e.g., 111₁) attached to the circuit board. Each of the one or more circuits comprises transmitter circuitry (e.g., 254_{1,1} to 254_{2,2} and portions of 256₁ and 249₁) communicatively coupled to a subset of the first plurality of antennas (e.g., 106_{1,1} to 106_{2,2}) and receiver circuitry (e.g., 252_{1,1} to 252_{2,2} and portions of 256₁ and 249₁) communicatively coupled to the subset of the first plurality of antennas. The one or more circuits may comprise a first circuit (e.g., 111₁) and a second circuit (e.g., 111₂), where the first circuit is communicatively coupled to the second circuit via interconnect (e.g., 202) of the circuit board. The first circuit may be communicatively coupled to the first subset of the first plurality of antennas, the second circuit may be communicatively coupled to a second subset of the first plurality of antennas. The first circuit may operable to transmit a signal via the first subset of the antennas using a first one or more beamforming coefficients (e.g., corresponding to a first directionality of a primary antenna lobe), receive reflections of the signal via the first subset of the first plurality of antennas using the first one or more beamforming coefficients, and generate a first representation (e.g., pixel or voxel grid) of a scene based on the reflections of the signal. The second circuit may be operable to transmit the signal via the second subset of the first plurality of antennas using a second one or more beamforming coefficients (e.g., corresponding to the first directionality of a primary antenna lobe), receive reflections of the signal via the second subset of the antennas using the second one or more beamforming coefficients, and generate a second representation of the scene based on the reflections of the signal. The first circuit may be operable to send the first scene representation to the second circuit (e.g., via 202), and the second circuit may be operable to combine the first scene representation and the second scene representation to generate an aggregate scene representation. The first plurality of antennas may be formed (e.g., cast or molded) from a single-piece substrate. Each of the first plurality of antennas may be a horn antenna (e.g., rectangular or conical). The substrate may be a non-conductive material (e.g., polycarbonate) plated with a conductive material. The array may be a two-dimensional array. The one or more circuits may comprise beamforming circuitry (e.g., 256₁) operable to steer a transmit radiation pattern and/or receive radiation pattern in two dimensions. The first phased array radar assembly may be attached on or behind a bumper of the automobile such that the phased array radar assembly is positioned to transmit signals in a direction of travel of the automobile and receive reflections of the signals. The system may comprise a second phased array radar assembly (e.g., 100₂) configured to be attached to an automobile, wherein the second phased array radar assembly comprises: a second plurality of antennas (e.g., 106_{1,1}-106_{2,8}) arranged in an array and attached to a circuit board (e.g., 152); and one or more circuits (e.g., 111₁) attached to the circuit board, wherein each of the one or more circuits comprises: transmitter circuitry (e.g., 254_{1,1} to 254_{2,2} and portions of 256₁ and 249₁) communicatively coupled to a subset of the second plurality of antennas, and receiver circuitry (e.g., 252_{1,1} to 252_{2,2} and portions of 256₁ and 249₁) communicatively coupled to a subset of the second plurality of antennas. The first phased array radar assembly and the second phased array radar assembly may be operable to communicate wirelessly via the first plurality of antennas and the second plurality of antennas. The first phased array radar system and second phased array radar system may be mounted to the automobile in different locations (e.g., like 100₁ and 100₂) and maybe pointed in different directions. The transmit circuitry may be operable to transmit a signal comprising one or more orthogonal frequency division multiplexed (OFDM) frames, and the receive circuitry may be operable to receive and process reflections of the signal comprising the one or more OFDM frames to detect objects (e.g., 440) off of which the signal reflected. The first plurality of antennas may be attached to a first side of the circuit board and the one or more circuits may be attached to a second side of the circuit board opposite the first side.

The present method and/or system may be realized in hardware, software, or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.). As used herein, “microwave” frequencies range from approximately 300 MHz to 300 GHz and “millimeter wave” frequencies range from approximately 30 GHz to 300 GHz. Thus, the “microwave” band includes the “millimeter wave” band.

What is claimed is:

1. A system comprising:
a first phased array radar assembly configured to be attached to a vehicle, wherein the first phased array radar assembly comprises:
a first plurality of antennas arranged in an array and attached to a first circuit board;
one or more circuits attached to the first circuit board, wherein each of the one or more circuits comprises:
transmitter circuitry communicatively coupled to a subset of the first plurality of antennas; and
receiver circuitry communicatively coupled to the subset of the first plurality of antennas.
